(19) United States
(12) Patent Application Publication
(10) Pub. No.: US 2006/0230913 A1
(43) Pub. Date: Oct. 19, 2006

(54) Controller for an electronic keyboard instrument that can be folded up and rolled up

(75) Inventor: Been-Tzaw Liao, Taichung City (TW)

Correspondence Address: CHARLES E. BAXLEY, ESQ., 90 JOHN STREET, THIRD FLOOR, NEW YORK, NY, 10038, US

(73) Assignee: Guten Electronics Industrial Co., Ltd.

(21) Appl. No.: 11/106,326

(22) Filed: Apr. 14, 2005

(51) Int. Cl. G10H 1/32; G10H 3/00

(52) U.S. Cl. 84/744

(57) ABSTRACT

A controller electrically connected to a keyboard consisting of a set of white keys and black keys through a flexible ribbon cable for controlling the operation of the keyboard is disclosed to include an external operating interface, which has a speaker, a display, and a set of operating buttons respectively mounted on a cover shell thereof, and an internal control unit, which is mounted outside the cover shell of the external operating interface and has a microprocessor, a memory, and a power unit. The microprocessor has an input side electrically connected to the flexible cable and the operating buttons of the external operating interface, and an output side electrically connected to the speaker and the display. The memory is electrically connected to the microprocessor and controlled by the microprocessor for data access. The power unit provides the microprocessor with the necessary working voltage.

### BACKGROUND OF THE INVENTION

1. Field of the Invention

The present invention relates to a foldable electronic keyboard instrument and more particularly, to a controller for an electronic keyboard instrument that can be folded up and rolled up.

2. Description of the Related Art

U.S. Pat. No. 6,259,006 discloses a portable and foldable modular electronic keyboard which includes a keyboard having a plurality of white and black keys capable of reproducing the notes of a piano through an individual headphone by using associated electronics. The foldable keyboard is formed from a plurality of modules, each module having a plurality of white and black keys, and each module being joined to another module by a flexible membrane. When the modules are folded together, the keyboard has the volume of a book. When the modules are unfolded, the keyboard presents a genuine piano keyboard with seven octaves. The white keys and the black keys forming each module have a low thickness.

The aforesaid design of modular electronic keyboard is highly portable and foldable. However, it must be used with a computer, which has installed therein a control software that controls the operation of the keys of the modular electronic keyboard. Due to the limitation of the connection between the modular electronic keyboard and the computer, the modular electronic keyboard cannot be moved away from the computer beyond the distance within which the connection line between the modular electronic keyboard and the computer is reachable. Further, due to the limitation of the control software, the modular electronic keyboard is not usable with a computer without the control software.

### SUMMARY OF THE INVENTION

The present invention has been accomplished under the circumstances in view. It is the main object of the present invention to provide a controller for an electronic keyboard instrument that has a small size and a light weight and provides versatile functions. It is another object of the present invention to provide a controller for an electronic keyboard instrument, which enables the electronic keyboard instrument to be operated independently without a computer.

To achieve these and other objects of the present invention, the controller is electrically connected to a keyboard through a flexible ribbon cable for controlling the operation of the keyboard. The keyboard consists of a having a set of white keys and black keys. The controller comprises an external operating interface and an internal control unit. The external operating interface comprises a speaker, a display, and a set of operating buttons respectively mounted on a cover shell thereof. The internal control unit is mounted inside the cover shell of the external operating interface, comprising a microprocessor, a memory, and a power unit, wherein the microprocessor has an input side electrically connected to the flexible cable and the operating buttons of the external operating interface, and an output side electrically connected to the speaker and the display; the memory is electrically connected to the microprocessor and controlled by the microprocessor for data access; the power unit provides electricity to the microprocessor.

### BRIEF DESCRIPTION OF THE DRAWINGS

FIG. 1 is a plain view of an electronic keyboard instrument according to the present invention.

FIG. 2 is an enlarged view of a part of FIG. 1.

FIG. 3 is a side view of the controller according to the present invention.

FIG. 4 is a schematic drawing showing the electronic keyboard instrument arranged in a curved condition according to the present invention.

FIG. 5 is a schematic drawing showing the electronic keyboard instrument arranged in a straight manner according to the present invention.

FIG. 6 is a schematic drawing showing the keyboard wound around the controller according to the present invention.

FIG. 7 is a block diagram of the internal control unit of the controller according to the present invention.

### DETAILED DESCRIPTION OF THE PREFERRED EMBODIMENT

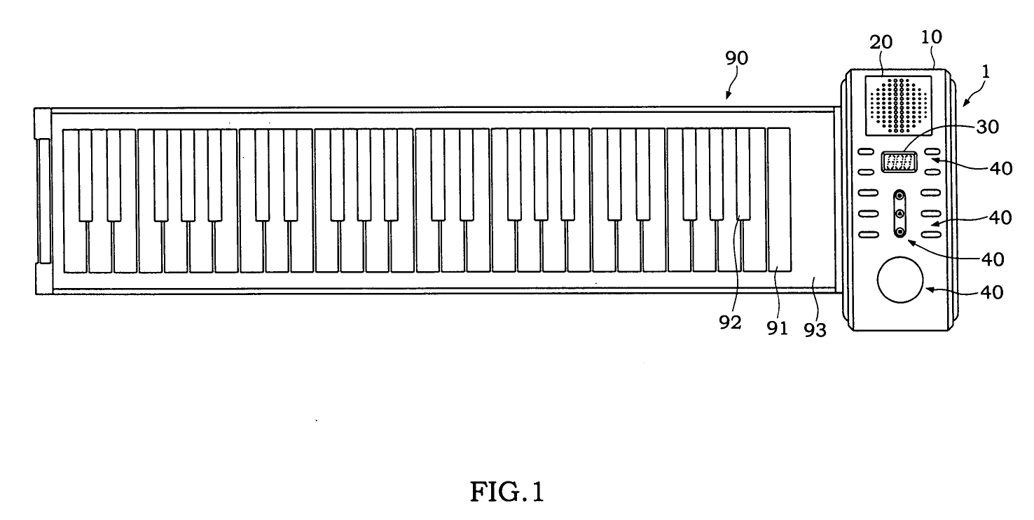

Referring to FIG. 1, an electronic keyboard instrument is shown comprising a keyboard 90, and a controller 1. The keyboard 90 comprises a flexible membrane 93 made of electrically insulative materials, and a plurality of keys including white keys 91 and black keys 92 for semitones like real pianos. The keys 91;92 are bonded to the top surface of the membrane 93. The controller 1 is connected to one end (lateral side) of the membrane 93, comprising an external operating interface and an internal control unit.

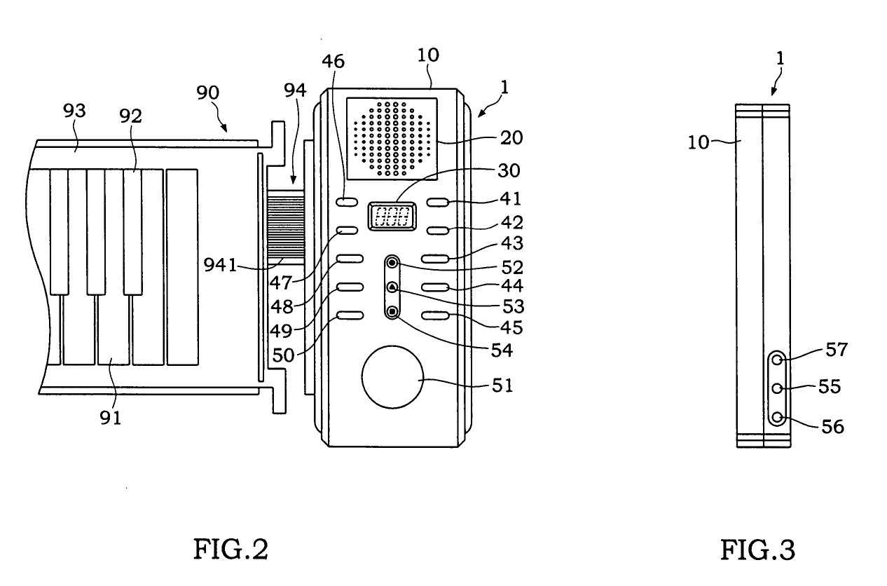

Referring to FIG. 2 and FIG. 1 again, a flexible ribbon cable 94 is connected between the keyboard 90 and the controller 1, comprising a plurality of flexible wire conductors 941 that connect the keys 91;92 of the keyboard 90 and the external operating interface of the controller 1 to the internal control unit of the controller 1 electrically. The external operating interface of the controller 1 comprises a cover shell 10, a speaker 20, a display 30, and a set of operating buttons 40.

The set of operating buttons 40 includes an upward selection button 41, a downward selection button 42, fun gain control button 43, program selector button 44, power on/off button 45, vibrato button 46, sequencer control button 47, piano sound selector button 48, bass control button 49, start/end button 50, volume control button 51, record button 52, replay button 53, and stop button 54.

The power on/off button 45 controls power on/off of the controller 1.

The program selector button 44 controls playing of built-in music compositions subject to the selection through the upward selection button 41 or the downward selection button 42, and the selected music composition will be outputted through the speaker 20 and indicated on the display 30.

The fun gain control button 43 is to be used with the program selector button 44. After selection of the desired music composition, the user can press on the fun gain control button 43 and then press any of the keys 91;92 to have a first musical tone of the selected music composition be played and outputted through the speaker 20. When the user presses any of the keys 91;92 again, a second musical tone of the selected music composition will be played and outputted through the speaker 20. When pressed off the fun gain control button 43, the fun gain function is canceled.

The tone selector button 48 controls the type of sound (for example, the sound of a piano, the sound of a violin, the sound of a synthesizer, the sound of an organ, the sound of a percussion, etc.) produced by the keys 91;92 subject to the selection through the upward selection button 41 or downward selection button 42, and the selected type of sound is indicated on the display 30.

The sequencer control button 47 control sequencing of the sound produced by each of the keys 91;92. When pressing any of the keys 91;92 after the sequencer control button 47 has been pressed without holding it in the depressed status, the sound produced will be sequenced and outputted through the speaker 20 in a decrescendo manner for about 2 seconds. When pressed the sequencer control button 47 again, the sequencing function will be immediately cancelled.

The vibrato button 48 controls vibration of the sound produced by each of the keys 91;92 at a specific frequency when it is pressed by the player. When pressed the vibrato button 48 again, the vibrato function is cancelled.

The bass control button 49 controls playing of the bass built in the internal control unit of the controller 1. After the bass control button 49 has been pressed, the player can select the rhythm of the bass through the upward selection button 41 or the downward selection button 42. The selected bass rhythm is displayed on the display 30. During playing of the bass subject to the selected rhythm, the sound produced by each of the keys 91;92 can still be outputted through the speaker 20. The rhythm of the bass works as the background music.

The start/end button 50 controls to play or to stop playing the aforesaid rhythm.

The volume control button 51 controls the output volume of sound through the speaker 20.

The record button 52, the replay button 53, and the stop button 54 are adapted to control recording of sounds produced by the electronic keyboard instrument, replaying of recorded sounds, or stopping of the recording action.

FIG. 3 is a side view of the controller 1. As illustrated, the controller 1 further comprises a power jack 55, an earphone jack 56, and an audio output jack 57. The power jack 55 is adapted to receive external power supply for the controller 1. The earphone jack 56 is for the connection of an earphone. The audio output jack 57 is for the connection of an external speaker or stereo system.

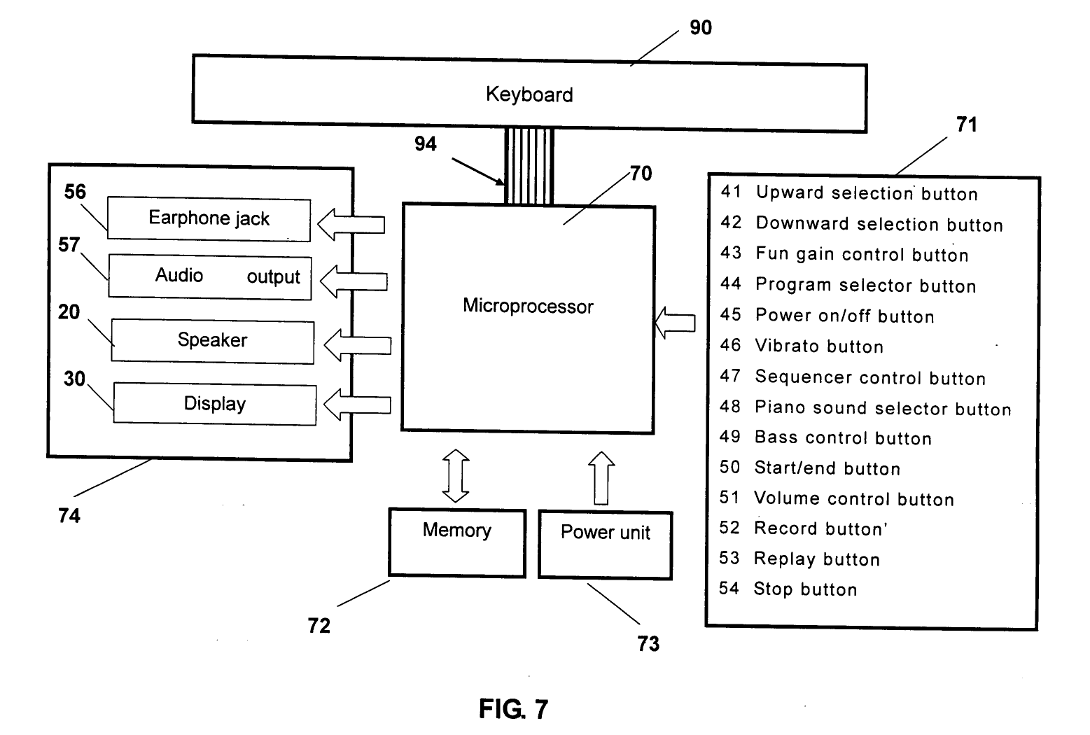

Referring to FIG. 7, the internal control unit of the controller 1 comprises a microprocessor 70, a memory 72, and a power supply unit 73. The speaker 20, display 30, earphone jack 56 and audio output jack 57 form an output unit 74 and are electrically connected to the output side of the microprocessor 70. The operating unit 71 formed of the operating buttons 40 of upward selection button 41, downward selection button 42, fun gain control button 43, program selector button 44, power on/off button 45, vibrato button 46, sequencer control button 47, piano sound selector button 48, bass control button 49, start/end button 50, volume control button 51, record button 52, replay button 53, and stop button 54 is electrically connected to the input side of the microprocessor 70 for function selection and operation control by the player. The keys 91;92 of the keyboard 90 are electrically connected to the input side of the microprocessor 70 by respective flexible wire conductors 941 that form a flexible ribbon cable 94.

The memory 72 is electrically connected to the aforesaid microprocessor, having stored therein music data including musical compositions, musical tones, bass rhythms, and sounds recorded by the user.

The power supply unit 73 provides the necessary working voltage to the aforesaid microprocessor and other parts of the present invention. The power supply unit 73 can be a battery pack or AC adapter.

The aforesaid microprocessor 70 controls the operation of the aforesaid operating unit 71, the output unit 74 and the memory 72. For example, the microprocessor 70 receives input message from the operating unit 71 or the keys 91;92, fetches data from the memory 72 subject to the message received from the operating unit 71 or the keys 91;92, converts fetched digital data into voices or numerical signs for output through the output unit 74. The microprocessor 70 can also convert inputted message from the keys 91;92 into digital signal and then control the memory 72 to store the signal.

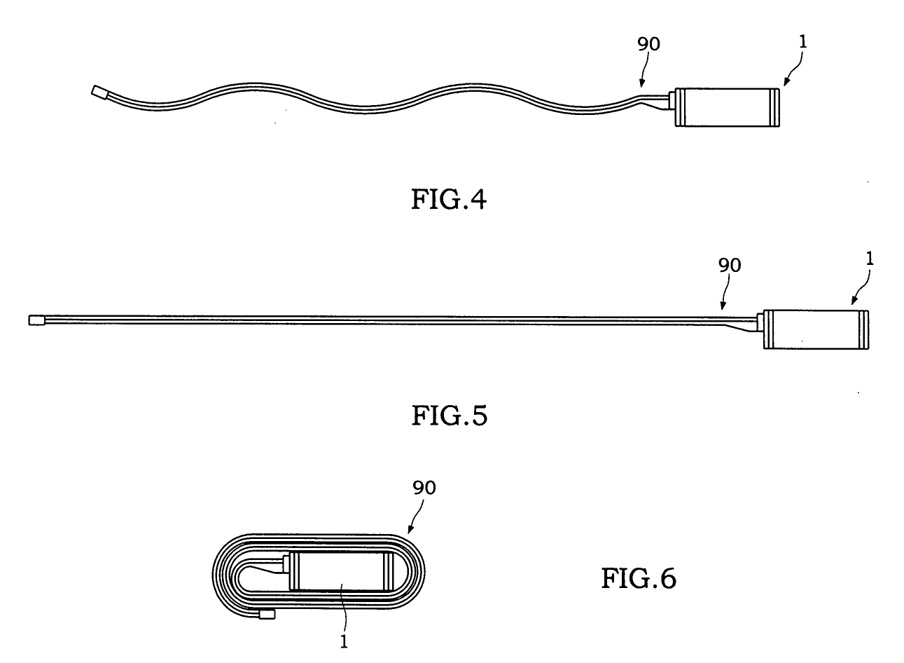

Referring to FIGS. 4 through 6, the keyboard 90 and the controller 1 are flexible and can be rolled up. FIG. 4 shows the keyboard 90 arranged in a curved condition. FIG. 5 shows the keyboard 90 fully extended out in a flat manner. FIG. 6 shows the keyboard 90 wound round the controller 1.

As indicated above, the present invention keeps the flexible, highly movable, small-sized, lightweight characteristics of the keyboard. The design of the controller 1 enables the keyboard to be operated independently without the use of a computer, i.e., the controller 1 enhances the mobility of the electronic keyboard instrument.

A prototype of electronic keyboard instrument controller has been constructed with the features of FIGS. 1-7. The electronic keyboard instrument controller functions smoothly to provide all the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A controller electrically connected to a keyboard consisting of a set of white keys and black keys through a flexible ribbon cable for controlling the operation of said keyboard, the controller comprising:
an external operating interface, said external operating interface comprising a speaker, a display, and a set of operating buttons respectively mounted on a cover shell thereof;
an internal control unit, said internal control unit mounted inside said cover shell of said external operating interface, said internal control unit comprising a microprocessor, a memory, and a power unit;
wherein said microprocessor has an input side electrically connected to said flexible cable and said operating buttons of said external operating interface, and an output side electrically connected to said speaker and said display; said memory is electrically connected to said microprocessor and controlled by said microprocessor for data access; said power unit provides electricity to said microprocessor.

2. The controller as claimed in claim 1, wherein said operating buttons include:
a power on/off button for controlling the supply of electricity to said microprocessor;
a tone selector button, which controls the selection of type of sound produced by each of said keys;
a bass control button for driving said microprocessor to output a sound of bass through said speaker; and
a volume control button-for driving said microprocessor to regulate the output volume -of sound through said speaker when operated.

3. The controller as claimed in claim 2, wherein said operating buttons further include an upward selection button and a downward selection button operable to drive said microprocessor to output the selected type of sound through said speaker.

4. The controller as claimed in claim 3, wherein said display is controllable by said microprocessor to display the code of said selected type of sound.

5. The controller as claimed in claim 2, wherein said operating buttons further include an upward selection button and a downward selection button operable to select the rhythm of the sound of bass to be outputted through said speaker after said bass control button has been pressed on.

6. The controller as claimed in claim 5, wherein said display is controllable by said microprocessor to display the rhythm of the sound of bas selected through said upward selection button and said downward selection button.

7. The controller as claimed in claim 2, wherein said operating buttons further include a program selector button controllable to drive said microprocessor to play built-in music compositions through said speaker.

8. The controller as claimed in claim 7, wherein said operating buttons further include an upward selection button and a downward selection button for selecting built-in music compositions and driving said microprocessor to output the selected built-in music compositions through said speaker after said program selector has been pressed on.

9. The controller as claimed in claim 8, wherein said display is controllable by said microprocessor to display the code of the built-in music compositions selected through said upward selection button and said downward selection button.

10. The controller as claimed in claim 8, wherein said operating buttons further include a fun gain control button, which drives said microprocessor to output one musical tone of the selected music composition through said speaker each time said fun gain control button is pressed.

11. The controller as claimed in claim 2, wherein said operating buttons further include:
a record button adapted to drive said microprocessor to record the sounds produced by the electronic keyboard instrument into said memory;
a stop button adapted to drive said microprocessor to stop recording action; and
a replay button adapted to drive said microprocessor to output the recorded data from said memory through said speaker.

12. The controller as claimed in claim 2, wherein said operating buttons further include a sequencer control button adapted to control sequencing of the sound produced by each of the keys of said keyboard.

13. The controller as claimed in claim 2, wherein said operating buttons further include a vibrato button adapted to control vibration of the sound produced by each of the keys of said keyboard at a predetermined frequency.

14. The controller as claimed in claim 1, wherein said external operating interface further comprises an earphone jack electrically connected to the output side of said microprocessor.

15. The controller as claimed in claim 1, wherein said external operating interface further comprises an audio output jack electrically connected to the output side of said microprocessor.
